(19) United States
(12) Patent Application Publication
(10) Pub. No.: US 2026/0320421 A1
(43) Pub. Date: Oct. 15, 2026

(54) METHOD AND SYSTEM FOR GENERATING FUSED-EXPERT LARGE LANGUAGE MODEL FROM A SET OF LLMS

(71) Applicant: L&T TECHNOLOGY SERVICES LIMITED, Chennai (IN)

(72) Inventors: VIKRAM SUBRAMANI, Krishnagiri (IN); SUDHIR BHADAURIA, Ahmedabad (IN)

(21) Appl. No.: 19/308,418

(22) Filed: Aug. 25, 2025

(30) Foreign Application Priority Data
Apr. 9, 2025 (IN) 202541034670

(51) Int. Cl. G06N 5/022

(52) U.S. Cl. CPC G06N 5/022

(57) ABSTRACT

A method and system for generating fused-expert large language model (LLM) from a set of LLMs is disclosed. A processor receives a set of tasks and a test dataset for each of the set of tasks. A first output for each of the set of tasks is determined by querying each of the set of LLMs based on the test dataset. A set of expert LLMs is determined from the set of LLMs based on an evaluation of the first output for each of the set of tasks. A knowledge database is determined based on a second output received by querying each of the set of expert LLMs. The set of expert LLMs are merged to generate a base LLM. A Parameter-Efficient Fine-Tuned (PEFT) model is created. A fused-expert LLM is generated by iteratively updating the PEFT model based on a knowledge distillation loss.

### TECHNICAL FIELD

This disclosure relates generally to the field of Large Language Models (LLMs), and more particularly to a method and system for generating a fused-expert LLM from a set of LLMs.

### BACKGROUND

Large Language Models (LLMs) have made significant progress in performing a variety of natural language processing (NLP) tasks. These tasks include text summarization, question answering, segment analysis, creative test generation, and code generation, among many others. LLMs are trained on vast amounts of data and have shown the ability to understand and generate human-like text with impressive accuracy. As a result, they are increasingly being used across different fields, such as healthcare, transportation, and software development, to automate and improve various text-based tasks. However, not all LLMs are equally good at every task. Some models are better at answering questions, while others may perform better at summarizing large documents or generating computer code. This is because each LLM is often trained and fine-tuned on specific types of data or for specific tasks. Therefore, the performance of a particular LLM can vary depending on the type of task in which it is used.

The challenge lies in choosing the right LLM for a specific task. In many cases, it is not clear which LLM will give the best results for a particular task. While it is possible to use multiple LLMs together to improve performance, doing so requires a lot of computing power and can be very expensive. Running multiple LLMs at the same time slows down the process and consumes more resources. Additionally, combining the knowledge and capabilities of multiple LLMs into a single model is not easy. Existing methods for merging LLMs often require a complex and time-consuming process called fine-tuning, which involves adjusting the model using large datasets. The process increases the cost and time needed to develop an effective solution. Even after merging, there may be a risk that the final model may not perform well across differ tasks, or it may lose the specialized abilities of the individual models.

Therefore, there is a requirement for an efficient methodology of generating a fused-expert LLM from a set of LLMs so that LLMs can work together efficiently and provide high-quality results across various tasks, without requiring excessive computing resources.

### SUMMARY OF THE INVENTION

In an embodiment, a method of generating a fused-expert large language model (LLM) from a set of LLMs is disclosed. The method may include receiving, by a processor, a set of tasks and a test dataset for each of the set of tasks. The method may further include determining, by the processor, a first output for each of the set of tasks by querying each of the set of LLMs based on the test dataset. The method may further include determining, by the processor, a set of expert LLMs from the set of LLMs based on an evaluation of the first output for each of the set of tasks using one or more predefined evaluation metrics. In an embodiment, each expert LLM from the set of expert LLMs may correspond to one of the set of tasks. The method may further include determining, by the processor, a knowledge database based on a second output received by querying each of the set of expert LLMs based on a corresponding routed-train dataset. The method may further include merging, by the processor, the set of expert LLMs to generate a base LLM using a merging technique. The method may further include creating, by the processor, a Parameter-Efficient Fine-Tuned (PEFT) model by generating a plurality of adapters within the base LLM using an adapter creation technique. The method may further include generating, by the processor, a fused-expert LLM by iteratively updating the PEFT model based on a knowledge distillation loss. In an embodiment, the knowledge distillation loss may be determined for each of a plurality of iterations based on a third output generated by the PEFT model based on a batch dataset and the knowledge database.

In another embodiment, a system for generating a fused-expert large language model (LLM) from a set of LLMs is disclosed. The system may include a processor, and a memory communicatively coupled to the processor, wherein the memory stores processor-executable instructions, which, when executed by the processor cause the processor to receive a set of tasks and a test dataset for each of the set of tasks. The processor may further determine a first output for each of the set of tasks by querying each of the set of LLMs based on the test dataset. The processor may further determine a set of expert LLMs from the set of LLMs based on an evaluation of the first output for each of the set of tasks using one or more predefined evaluation metrics. In an embodiment, each expert LLM from the set of expert LLMs may correspond to one of the set of tasks. The processor may further determine a knowledge database based on a second output received by querying each of the set of expert LLMs based on a corresponding routed-train dataset. The processor may further merge the set of expert LLMs to generate a base LLM using a merging technique. The processor may further create a Parameter-Efficient Fine-Tuned (PEFT) model by generating a plurality of adapters within the base LLM using an adapter creation technique. The processor may further generate a fused-expert LLM by iteratively updating the PEFT model based on a knowledge distillation loss. In an embodiment, the knowledge distillation loss may be determined for each of a plurality of iterations based on a third output generated by the PEFT model based on a batch dataset and the knowledge database.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating a fused-expert large language model (LLM) from a set of LLMs, in accordance with an embodiment of the present disclosure.

FIG. 2 is a functional block diagram of various modules within a memory of a computing device of FIG. 1, configured to generate the fused-expert LLM, in accordance with an embodiment of the present disclosure.

FIG. 3 illustrates an exemplary architecture diagram of generating the fused-expert LLM form the set of LLMs, in accordance with an embodiment of the present disclosure.

FIG. 4 illustrates a flowchart of a method of generating the fused-expert LLM from the set of LLMs, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

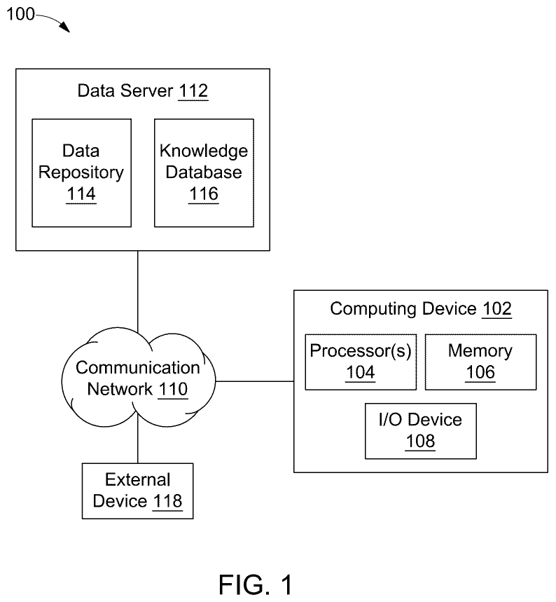

Referring now to FIG. 1, a block diagram of an exemplary system 100 for generating a fused-expert large language model (LLM) from a set of LLMs, is illustrated, in accordance with an embodiment of the present disclosure. The system 100 may include a computing device 102, a data server 112, and an external device 118 communicatively coupled to each other through a wired or wireless communication network 110. The computing device 102 may include a processor 104, a memory 106, and an input/output (I/O) device 108.

In an embodiment, examples of processor(s) 104 may include, but are not limited to, microcontrollers, microprocessors, digital signal processors (DSPs), application-specific integrated circuits (ASICs), field-programmable gate arrays (FPGAs), system-on-chip (SoC) components, or any other suitable programmable logic devices. Examples of processor(s) 104 may include but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors.

In an embodiment, the memory 106 may store instructions that, when executed by the processor 104, and cause the processor 104 to generate the fused-expert large language model (LLM), as will be discussed in greater detail herein below. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise a variety of interface(s), for example, interfaces for data input and output devices, and the like. The I/O device 108 may facilitate inputting of a set of tasks, a task dataset for each of the set of tasks, and a set of LLMs, by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the data server 112 may be implemented as a remote cloud server or a co-located server and may include a data repository 114 to store the set of tasks, the task dataset for each of the set of tasks, the test dataset for each of the set of tasks, the train dataset for each of the set of tasks, the set of LLMs, and a set of expert LLMs. The data repository 114 may further store a base LLM, a Parameter-Efficient Fine-Tuned (PEFT) model and a fused-expert LLM generated by the computing device 102, along with data necessary for the generation of the fused-expert LLM. In an embodiment, the data repository 114 may store data received from the external device 118, as well as output generated by the computing device 102. In an embodiment, the data server 112 may also include a knowledge database 116 to store a second output from each of the set of expert LLMs, and a batch dataset. In an embodiment, the computing device 102 may be communicatively coupled with the data server 112 through the communication network 110.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network 110 can include a variety of network devices, including routers, bridges, servers, computing devices, storage devices, and the like.

In an embodiment, the computing device 102 may receive a user input for generating the fused-expert LLM from the set of LLMs from the external device 118 through the communication network 110. In an embodiment, the computing device 102 and the external device 118 may be a computing system, including but not limited to, a smart phone, a laptop computer, a desktop computer, a notebook, a workstation, a server, a portable computer, a handheld, or a mobile device. In an embodiment, the computing device 102 may be, but not limited to, in-built into the external device 118 or may be a standalone computing device.

In an embodiment, the computing device 102 may perform various processing in order to generate the fused-expert LLM from the set of LLMs. By way of an example, the computing device 102 may receive a set of tasks and a task dataset for each of the set of tasks as an input. In an embodiment, the set of tasks may include various types of natural language processing (NLP) tasks. Examples of such tasks may include, but are not limited to, text summarization, question answering, text generation, sentiment analysis, code generation, reasoning, and creative text generation. In an embodiment, each task from the set of tasks may correspond to a domain from a set of domains. In an embodiment, the set of domains may include, but are not limited to, healthcare, transportation, finance, legal, education, e-commerce, and software development. For instance, text summarization may be used to generate concise summaries of lengthy documents, such as medical reports, legal documents, or technical manuals. Question answering tasks may involve extracting or generating accurate answers from a given context, such as consumer support FAQs or knowledge bases. Code generation tasks may focus on generating source code in programming languages such as Python, Java, or C++ based on natural language descriptions or specifications.

The computing device 102 may also receive the set of LLMs as an input. In an embodiment, each LLM may be pre-trained on data corresponding to one or more domains from the set of domains. In an embodiment, each LLM within the set of LLMs may exhibit varying levels of expertise depending on its pre-training objectives, the structure of its training data, and the method used in its development. For example, one LLM may be specialized in understanding and generating medical terminology and clinical documentation due to its pretraining on electronic health records and biomedical literature. Another LLM may be optimized for software code generation and technical reasoning by virtue of being trained on large-scale code repositories and software documentation.

It should be noted that the input may be indicated or provided by a user via the I/O device 108. For example, the user may indicate a file path corresponding to the location of the task dataset for each of the set of tasks and the set of LLMs or may directly upload the task dataset and the set of LLMs to the computing device 102 through the I/O device 108.

Further, the computing device 102 may split the task dataset for each of the set of tasks into a test dataset and a train dataset corresponding to each of the set of tasks using a splitting technique. In an embodiment, the splitting technique may include, but are not limited to, a random splitting technique, a stratified sampling technique, a time-based splitting technique, a cross-validation splitting technique. In an embodiment, the splitting technique may involve partitioning the task dataset into two or more subsets, typically referred to as the test dataset and the train dataset.

Thereafter, the computing device 102 may determine a first output for each of the set of tasks by querying each of the set of LLMs based on the test dataset corresponding to each of the set of tasks. In an embodiment, in order to determine the first output for each of the set of tasks, individual samples from the test dataset may be inputted into each of the set of LLMs.

Thereafter, the computing device 102 may determine a set of expert LLMs from the set of LLMs based on an evaluation of the first output for each of the set of tasks using one or more predefined evaluation metrics. In an embodiment, each expert LLM from the set of expert LLMs may correspond to one of the set of tasks. In an embodiment, the computing device 102, in order to evaluate the first output, may compare the first output generated by each LLM for a particular task against a ground truth or reference output that is associated with the test dataset. In an embodiment, the one or more predefined evaluation metrics may include, but are not limited to, Recall-Oriented Understudy for Gisting Evaluation (ROUGE) score, BERT (Bidirectional Encoder Representations from Transformers) score, Summary Consistency (SummaC) score, Exact Match (EM) score, F-measure (F1) score, BiLingual Evaluation Understudy (BLEU) score, and codeBLEU score. In an embodiment, the predefined evaluation metrics may be selected based on the task being performed. For example, for tasks such as text summarization, the computing device 102 may use the Recall-Oriented Understudy for Gisting Evaluation (ROUGE) score, which measures the overlap between the generated summaries and the reference summaries. ROUGE metrics may include ROUGE-1, which evaluates unigram overlap, ROUGE-2, which evaluates bigram overlap, and ROUGE-L, which measures the longest common subsequence between the generated texts (i.e., the first output) and reference texts. In addition, BERT (Bidirectional Encoder Representations from Transformers) score may be used to assess semantic similarity between the generated summary (i.e., the first output) and the reference summary by utilizing contextual embeddings generated (i.e., the first output) by a pre-trained BERT model. Summary Consistency (SummaC) score may also be applied to evaluate the factual consistency of the generated summaries (i.e., the first output). For question answering (QA) tasks, the evaluation metrics may include the Exact Match (EM) score, which measures whether the generated answer (i.e., the first output) exactly matches the reference answer. The F-measure (F1) score, which calculates the harmonic mean of precision and recall, may also be used to assess how well the tokens in the generated answer (i.e., the first output) overlap with the reference answer. Additionally, the BLEU (BiLingual Evaluation Understudy) score may be used to evaluate QA tasks where answers (i.e., the first output) are generated in natural language. For code generation tasks, the computing device 102 may apply the codeBLEU score, which extends the traditional BLEU metric by incorporating additional factors such as abstract syntax tree (AST) similarity, data flow, and code structure alignment.

The computing device 102 may further determine the knowledge database 116 based on a second output received by querying each of the set of expert LLMs based on a corresponding routed-train dataset. In an embodiment, the corresponding routed-train dataset for each of the set of tasks may be determined by routing the train dataset to each of the set of expert LLMs based on a task expertise of each of the set of expert LLMs. For example, if an expert LLM has been identified as the best-performing model for a text summarization task, the computing device 102 may route all training samples pertaining to text summarization from the train dataset to that expert LLM. Similarly, if another expert LLM is designated for code generation, the computing device 102 may route all code generation-related training samples from the train dataset to that expert LLM. This routing process ensures that each expert LLM is exposed only to data samples that align with its area of proficiency. Upon receiving the routed-train dataset, each expert LLM may generate a second output by processing the corresponding routed-train dataset.

Further, the computing device 102 may merge the set of expert LLMs to generate a base LLM using a merging technique. In an embodiment, the merging process may be performed by the computing device 102 and may involve combining the parameters, weights, or embeddings of the set of expert LLMs into a single unified model, referred to as the base LLM. The merging technique may be designed to retain the task-specific expertise of each expert LLM while enabling the resulting base LLM to generalize across multiple tasks. In an embodiment, the merging technique may include, but is not limited to, parameter averaging, weighted parameter blending, layer-wise selective merging, or other structured optimization methods. For example, in a parameter averaging approach, the corresponding parameters (such as weights and biases) of each expert LLM may be averaged to produce a combined set of parameters for the base LLM.

The computing device 102 may further create a Parameter-Efficient Fine-Tuned (PEFT) model by generating a plurality of adapters within the base LLM using an adapter creation technique. In an embodiment, adapter creation involves adding lightweight neural network modules, referred to as adapters, into specific layers or components of the base LLM. These adapters enable fine-tuning of the base LLM on task-specific data without requiring modification of the core model parameters, thereby significantly reducing the computational cost and memory footprint of the fine-tuning process. In an embodiment, the adapter creation technique may include, but are not limited to, a Low-Rank Adaptation (LoRA) technique, a Prefix Tuning technique, a BitFit technique, or a custom adapter architecture technique. For example, in LoRA-based PEFT, the adapters are low-rank decomposition matrices that are inserted into the linear transformation layers of the base LLM. These adapters are trainable, while the original model parameters remain frozen. In an embodiment, the computing device 102 may insert adapters into different components of the base LLM, such as attention layers, feed-forward layers, or embedding layers, depending on the architecture of the base LLM and the desired level of fine-tuning.

Further, the computing device 102, for each of a plurality of iterations, may determine a knowledge distillation loss. In an embodiment, the knowledge distillation loss may be used to guide the training of the PEFT model to ensure that the PEFT model learns to replicate or approximate the task-specific outputs of the expert LLMs while maintaining computational efficiency. The computing device 102, in order to determine the knowledge distillation loss for each of the plurality of iterations, may determine a set of input-output pairs based on the second output from each of the set of expert LLMs and a corresponding batch dataset. In an embodiment, the second output, previously generated by querying each expert LLM with its corresponding routed-train dataset, may have been stored in the knowledge database 116. In an embodiment, the batch dataset may be generated from the train dataset using a batch generator for each of the plurality of iterations. In an embodiment, the batch generator may divide the train dataset into smaller, manageable subsets or batches, each containing a fixed number of training samples. In an embodiment, the batch size may be predetermined based on system resources and training requirements and may ensure optimal utilization of memory and processing capabilities during each iteration. In an embodiment, the knowledge distillation loss for each of the plurality of iterations may be determined by comparing a third output and the set of input-output pairs using a loss determination technique. In an embodiment, the third output may be generated by the PEFT model based on the batch dataset and the knowledge database 116. For each batch dataset, the computing device 102 may retrieve the corresponding input-output pairs from the knowledge database 116. These input-output pairs serve as the ground truth or “teacher” outputs provided by the expert LLMs, against which the “student” outputs (i.e., the third output) of the PEFT model will be compared.

In an embodiment, the comparison between the third output and the set of input-output pairs may be performed using the loss determination technique. In an embodiment, the loss determination technique may include, but is not limited to, a combination of a soft loss and a hard loss. In an embodiment, the soft loss may include Kullback-Leibler (KL) divergence on softened logits and the hard loss may include cross-entropy loss with true labels.

Accordingly, the computing device 102 may generate a fused-expert LLM by iteratively updating the PEFT model based on the knowledge distillation loss. In an embodiment, after determining the knowledge distillation loss for each of a plurality of iterations, the computing device 102 may utilize the computed knowledge distillation loss to update the trainable parameters associated with the adapters in the PEFT model. In an embodiment, these updates may be performed using standard optimization algorithms such as Stochastic Gradient Descent (SGD), Adam, RMSProp, or other suitable gradient-based learning methods. In an embodiment, the fused-expert LLM may be stored in the data repository 114 of the data server 112 for subsequent deployment or inference tasks. The fused-expert LLM may be configured for the set of tasks, including but not limited to, text summarization, question answering, code generation, sentiment analysis, and reasoning tasks, across the set of domains including but not limited to, healthcare, transportation, and software development.

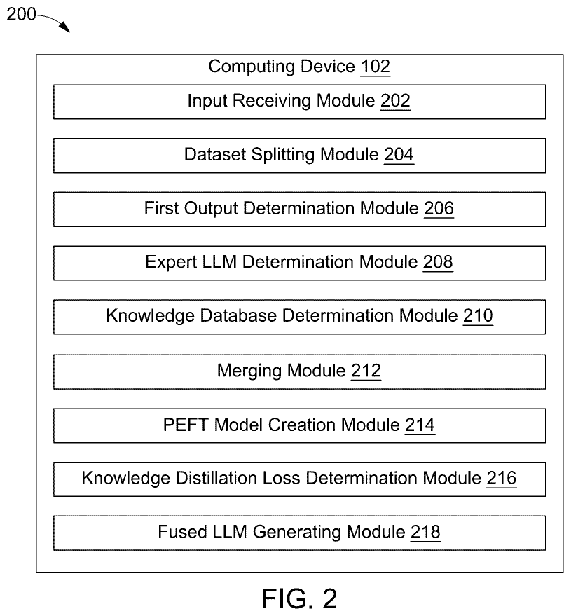

Referring now to FIG. 2, a functional block diagram 200 of various modules within the memory 106 of the computing device 102 of FIG. 1, configured to generate the fused-expert LLM, is illustrated, in accordance with an embodiment of the present disclosure. FIG. 2 is explained in conjunction with FIG. 1. The memory 106 may store an input receiving module 202, a dataset splitting module 204, a first output determination module 206, an expert LLM determination module 208, a knowledge database determination module 210, a merging module 212, a PEFT model creation module 214, a knowledge distillation loss determination module 216, and a fused LLM generation module 218.

The input receiving module 202 may receive a set of tasks and a task dataset for each of the set of tasks as an input. In an embodiment, the set of tasks may include various types of natural language processing (NLP) tasks. Examples of such tasks may include, but are not limited to, text summarization, question answering, text generation, sentiment analysis, code generation, reasoning, and creative text generation. In an embodiment, each task from the set of tasks may correspond to a domain from a set of domains. In an embodiment, the set of domains may include, but are not limited to, healthcare, transportation, finance, legal, education, e-commerce, and software development. For instance, text summarization may be used to generate concise summaries of lengthy documents, such as medical reports, legal documents, or technical manuals. Question answering tasks may involve extracting or generating accurate answers from a given context, such as consumer support FAQs or knowledge bases. Code generation tasks may focus on generating source code in programming languages such as Python, Java, or C++ based on natural language descriptions or specifications.

The input receiving module 202 may also receive a set of LLMs as an input. In an embodiment, each LLM may be pre-trained on data corresponding to one or more domains from a set of domains. In an embodiment, each LLM within the set of LLMs may exhibit varying levels of expertise depending on its pre-training objectives, the structure of its training data, and the method used in its development. For example, one LLM may be specialized in understanding and generating medical terminology and clinical documentation due to its pretraining on electronic health records and biomedical literature. Another LLM may be optimized for software code generation and technical reasoning by virtue of being trained on large-scale code repositories and software documentation.

It should be noted that the input may be indicated or provided by a user via the I/O device 108. For example, the user may indicate a file path corresponding to the location of the task dataset for each of the set of tasks and the set of LLMs or may directly upload the task dataset and the set of LLMs to the input receiving module 202 through the I/O device 108.

Further, the dataset splitting module 204 may split the task dataset for each of the set of tasks into a test dataset and a train dataset corresponding to each of the set of tasks using a splitting technique. In an embodiment, the splitting technique may include, but are not limited to, a random splitting technique, a stratified sampling technique, a time-based splitting technique, a cross-validation splitting technique. In an embodiment, the splitting technique may involve partitioning the task dataset into two or more subsets, typically referred to as the test dataset and the train dataset.

Thereafter, the first output determination module 206 may determine a first output for each of the set of tasks by querying each of the set of LLMs based on the test dataset corresponding to each of the set of tasks. In an embodiment, in order to determine the first output for each of the set of tasks, individual samples from the test dataset may be inputted into each of the set of LLMs.

Further, the expert LLM determination module 208 may determine a set of expert LLMs from the set of LLMs based on an evaluation of the first output for each of the set of tasks using one or more predefined evaluation metrics. In an embodiment, each expert LLM from the set of expert LLMs may correspond to one of the set of tasks. In an embodiment, the expert LLM determination module 208, in order to evaluate the first output, may compare the first output generated by each LLM for a particular task against a ground truth or reference output that is associated with the test dataset. In an embodiment, the one or more predefined evaluation metrics may include, but are not limited to, Recall-Oriented Understudy for Gisting Evaluation (ROUGE) score, BERT (Bidirectional Encoder Representations from Transformers) score, Summary Consistency (SummaC) score, Exact Match (EM) score, F-measure (F1) score, BiLingual Evaluation Understudy (BLEU) score, and codeBLEU score. In an embodiment, the predefined evaluation metrics may be selected based on the task being performed. For example, for tasks such as text summarization, the expert LLM determination module 208 may use the Recall-Oriented Understudy for Gisting Evaluation (ROUGE) score, which measures the overlap between the generated summaries and the reference summaries. ROUGE metrics may include ROUGE-1, which evaluates unigram overlap, ROUGE-2, which evaluates bigram overlap, and ROUGE-L, which measures the longest common subsequence between the generated texts (i.e., the first output) and reference texts. In addition, BERT (Bidirectional Encoder Representations from Transformers) score may be used to assess semantic similarity between the generated summary (i.e., the first output) and the reference summary by utilizing contextual embeddings generated (i.e., the first output) by a pre-trained BERT model. Summary Consistency (SummaC) score may also be applied to evaluate the factual consistency of the generated summaries (i.e., the first output). For question answering (QA) tasks, the evaluation metrics may include the Exact Match (EM) score, which measures whether the generated answer (i.e., the first output) exactly matches the reference answer. The F-measure (F1) score, which calculates the harmonic mean of precision and recall, may also be used to assess how well the tokens in the generated answer (i.e., the first output) overlap with the reference answer. Additionally, the BLEU (BiLingual Evaluation Understudy) score may be used to evaluate QA tasks where answers (i.e., the first output) are generated in natural language. For code generation tasks, the expert LLM determination module 208 may apply the codeBLEU score, which extends the traditional BLEU metric by incorporating additional factors such as abstract syntax tree (AST) similarity, data flow, and code structure alignment.

Thereafter, the knowledge database determination module 210 may determine the knowledge database 116 based on a second output received by querying each of the set of expert LLMs based on a corresponding routed-train dataset. In an embodiment, the corresponding routed-train dataset for each of the set of tasks may be determined by routing the train dataset to each of the set of expert LLMs based on a task expertise of each of the set of expert LLMs. For example, if an expert LLM has been identified as the best-performing model for a text summarization task, the knowledge database determination module 210 may route all training samples pertaining to text summarization from the train dataset to that expert LLM. Similarly, if another expert LLM is designated for code generation, the knowledge database determination module 210 may route all code generation-related training samples from the train dataset to that expert LLM. This routing process ensures that each expert LLM is exposed only to data samples that align with its area of proficiency. Upon receiving the routed-train dataset, each expert LLM may generate a second output by processing the corresponding routed-train dataset.

Further, the merging module 212 may merge the set of expert LLMs to generate a base LLM using a merging technique. In an embodiment, the merging process may be performed by the merging module 212 and may involve combining the parameters, weights, or embeddings of the set of expert LLMs into a single unified model, referred to as the base LLM. The merging technique may be designed to retain the task-specific expertise of each expert LLM while enabling the resulting base LLM to generalize across multiple tasks. In an embodiment, the merging technique may include, but is not limited to, parameter averaging, weighted parameter blending, layer-wise selective merging, or other structured optimization methods. For example, in a parameter averaging approach, the corresponding parameters (such as weights and biases) of each expert LLM may be averaged to produce a combined set of parameters for the base LLM.

Thereafter, the PEFT model creation module 214 may create a Parameter-Efficient Fine-Tuned (PEFT) model by generating a plurality of adapters within the base LLM using an adapter creation technique. In an embodiment, adapter creation involves adding lightweight neural network modules, referred to as adapters, into specific layers or components of the base LLM. These adapters enable fine-tuning of the base LLM on task-specific data without requiring modification of the core model parameters, thereby significantly reducing the computational cost and memory footprint of the fine-tuning process. In an embodiment, the adapter creation technique may include, but are not limited to, a Low-Rank Adaptation (LoRA) technique, a Prefix Tuning technique, a BitFit technique, or a custom adapter architecture technique. For example, in LoRA-based PEFT, the adapters are low-rank decomposition matrices that are inserted into the linear transformation layers of the base LLM. These adapters are trainable, while the original model parameters remain frozen. In an embodiment, the PEFT model creation module 214 may insert adapters into different components of the base LLM, such as attention layers, feed-forward layers, or embedding layers, depending on the architecture of the base LLM and the desired level of fine-tuning.

Further, the knowledge distillation loss determination module 216, for each of a plurality of iterations, may determine a knowledge distillation loss. In an embodiment, the knowledge distillation loss may be used to guide the training of the PEFT model to ensure that the PEFT model learns to replicate or approximate the task-specific outputs of the expert LLMs while maintaining computational efficiency. The knowledge distillation loss determination module 216, in order to determine the knowledge distillation loss for each of the plurality of iterations, may determine a set of input-output pairs based on the second output from each of the set of expert LLMs and a corresponding batch dataset. In an embodiment, the second output, previously generated by querying each expert LLM with its corresponding routed-train dataset, may have been stored in the knowledge database 116. In an embodiment, the batch dataset may be generated from the train dataset using a batch generator for each of the plurality of iterations. In an embodiment, the batch generator may divide the train dataset into smaller, manageable subsets or batches, each containing a fixed number of training samples. In an embodiment, the batch size may be predetermined based on system resources and training requirements and may ensure optimal utilization of memory and processing capabilities during each iteration. In an embodiment, the knowledge distillation loss for each of the plurality of iterations may be determined by comparing a third output and the set of input-output pairs using a loss determination technique. In an embodiment, the third output may be generated by the PEFT model based on the batch dataset and the knowledge database 116. For each batch dataset, the knowledge distillation loss determination module 216 may retrieve the corresponding input-output pairs from the knowledge database 116. These input-output pairs serve as the ground truth or “teacher” outputs provided by the expert LLMs, against which the “student” outputs (i.e., the third output) of the PEFT model will be compared.

In an embodiment, the comparison between the third output and the set of input-output pairs may be performed using the loss determination technique. In an embodiment, the loss determination technique may include, but is not limited to, a combination of a soft loss and a hard loss. In an embodiment, the soft loss may include Kullback-Leibler (KL) divergence on softened logits and the hard loss may include cross-entropy loss with true labels.

Accordingly, the fused LLM generating module 218 may generate a fused-expert LLM by iteratively updating the PEFT model based on the knowledge distillation loss. In an embodiment, after determining the knowledge distillation loss for each of a plurality of iterations, the fused LLM generating module 218 may utilize the computed knowledge distillation loss to update the trainable parameters associated with the adapters in the PEFT model. In an embodiment, these updates may be performed using standard optimization algorithms such as Stochastic Gradient Descent (SGD), Adam, RMSProp, or other suitable gradient-based learning methods. In an embodiment, the fused-expert LLM may be stored in the data repository 114 of the data server 112 for subsequent deployment or inference tasks. The fused-expert LLM may be configured for the set of tasks, including but not limited to, text summarization, question answering, code generation, sentiment analysis, and reasoning tasks, across the set of domains including but not limited to, healthcare, transportation, and software development.

It should be noted that all such aforementioned modules 202-218 may be represented as a single module or a combination of different modules. Further, as will be appreciated by those skilled in the art, each of the modules 202-218 may reside, in whole or in parts, on one device or multiple devices in communication with each other. In some embodiments, each of the modules 202-218 may be implemented as dedicated hardware circuit comprising custom application-specific integrated circuit (ASIC) or gate arrays, off-the-shelf semiconductors such as logic chips, transistors, or other discrete components. Each of the modules 202-218 may also be implemented in a programmable hardware device such as a field programmable gate array (FPGA), programmable array logic, programmable logic device, and so forth. Alternatively, each of the modules 202-218 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for generating the fused-expert LLM from the set of LLMs. For example, the exemplary system 100 and the associated computing device 102 may generate the fused-expert LLM from the set of LLMs by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

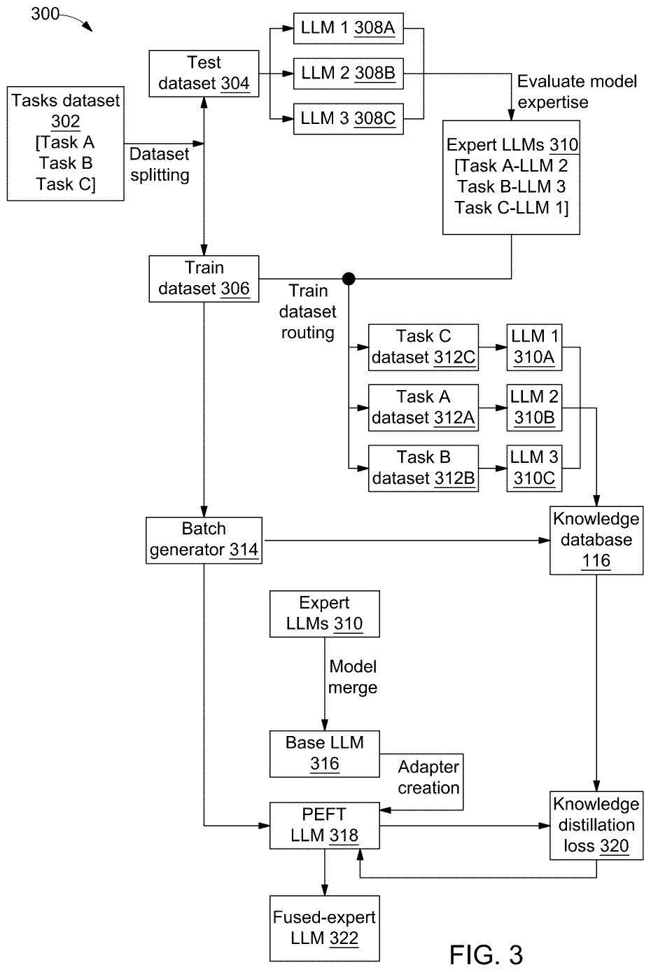

Referring now to FIG. 3, an exemplary architecture diagram 300 of generating a fused-expert LLM from a set of LLMs, is illustrated, in accordance with an embodiment of the present disclosure. FIG. 3 is explained in conjunction with FIGS. 1 and 2.

A set of tasks and a task dataset 302 for each of the set of tasks may be received as an input. Further, the task dataset 302 for each of the set of tasks may be split into a test dataset 304 and a train dataset 306 corresponding to each of the set of tasks using a splitting technique. Thereafter, a set of LLMs 308A, 308B, 308C (collectively referred to as a set of LLMs 308) may be received. In an embodiment, each LLM 308A, 308B, 308C may be pre-trained on data corresponding to one or more domains from a set of domains. In an embodiment, each tasks from the set of tasks may also correspond to a domain from the set of domains. Further, a first output for each of the set of tasks may be determined by querying each of the set of LLMs 308 based on the test dataset 304 corresponding to each of the set of tasks.

Thereafter, a set of expert LLMs 310A, 310B, 310C (collectively referred to as a set of expert LLMs 310) from the set of LLMs 308 may be determined based on an evaluation of the first output for each of the set of tasks using one or more predefined evaluation metrics. In an embodiment, each expert LLM 310A, 310B, 310C from the set of expert LLMs 310 may correspond to one of the set of tasks. In an embodiment, the one or more predefined evaluation metrics may include, but are not limited to, Recall-Oriented Understudy for Gisting Evaluation (ROUGE) score, BERT (Bidirectional Encoder Representations from Transformers) score, Summary Consistency (SummaC) score, Exact Match (EM) score, F-measure (F1) score, BiLingual Evaluation Understudy (BLEU) score, and codeBLEU score.

Thereafter, the knowledge database 116 may be determined based on a second output received by querying each of the set of expert LLMs 310A, 310B, 310C based on a corresponding routed-train dataset 312C, 312A, 312B. In an embodiment, the corresponding routed-train dataset 312C, 312A, 312B for each of the set of tasks may be determined by routing the train dataset 306 to each of the set of expert LLMs 310A, 310B, 310C. Further, the set of expert LLMs 310A, 310B, 310C may be merged to generate a base LLM 316 using a merging technique. A Parameter-Efficient Fine-Tuned (PEFT) model 318 may be created by generating a plurality of adapters within the base LLM 316 using an adapter creation technique.

Further, for each of a plurality of iterations, a knowledge distillation loss 320 may be determined. In order to determine the knowledge distillation loss 320 for each of the plurality of iterations, a set of input-output pairs may be determined based on the second output from each of the set of expert LLMs and a corresponding batch dataset. In an embodiment, the batch dataset may be generated from the train dataset using a batch generator 314 for each of the plurality of iterations. In an embodiment, the knowledge distillation loss 320 may be determined by comparing a third output and the set of input-output pairs using a loss determination technique. In an embodiment, the third output may be generated by the PEFT model 318 based on the batch dataset and the knowledge database 116. In an embodiment, the comparison between the third output and the set of input-output pairs may be performed using the loss determination technique. In an embodiment, the loss determination technique may include, but is not limited to, a combination of a soft loss and a hard loss. In an embodiment, the soft loss may include Kullback-Leibler (KL) divergence on softened logits and the hard loss may include cross-entropy loss with true labels. Accordingly, a fused-expert LLM 322 may be generated by iteratively updating the PEFT model 316 based on the knowledge distillation loss 320.

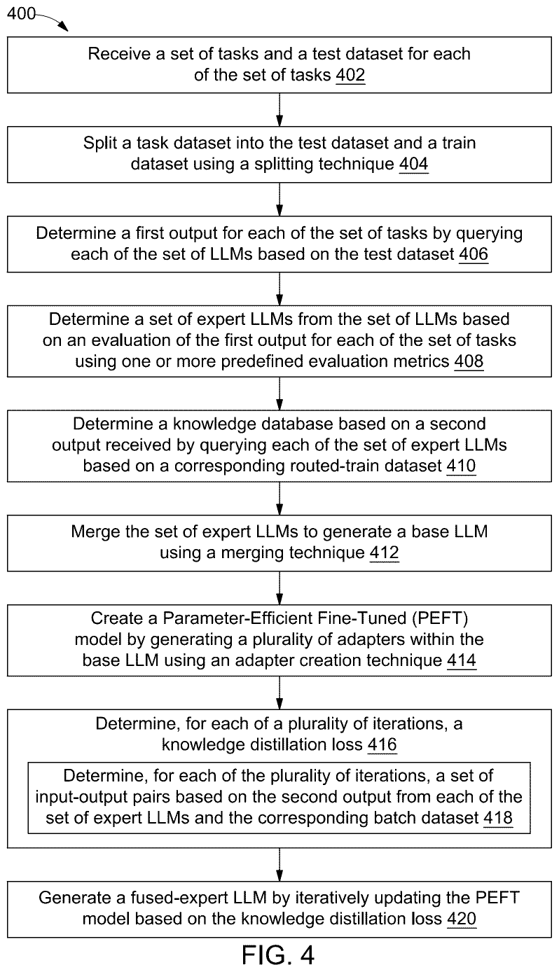

Referring now to FIG. 4, a flowchart 400 of a method of generating a fused-expert LLM from a set of LLMs, is illustrated, in accordance with an embodiment of the present disclosure. FIG. 4 is explained in conjunction with FIGS. 1 and 2. In an embodiment, the flowchart 400 may include a plurality of steps. Each step of the flowchart 400 may be executed by various modules, same as the modules of the computing device 102 so as to generate a fused-expert LLM from the set of LLMs.

At step 402, a set of tasks and a test dataset for each of the set of tasks may be received as an input. In other words, a set of tasks and a task dataset for each of the set of tasks may be received as an input. In an embodiment, the set of LLMs may also be received as an input. In an embodiment, each LLM may be pre-trained on data corresponding to one or more domains from a set of domains. In an embodiment, each task from the set of tasks may also correspond to a domain from the set of domains. It should be noted that the input may be indicated or provided by a user via the I/O device 108. For example, the user may indicate a file path corresponding to the location of the task dataset for each of the set of tasks and the set of LLMs or may directly upload the task dataset and the set of LLMs to the computing device 102 through the I/O device 108.

Further at step 404, the task dataset for each of the set of tasks may be split into the test dataset and a train dataset corresponding to each of the set of tasks using a splitting technique. Further at step 406, a first output for each of the set of tasks may be determined by querying each of the set of LLMs based on the test dataset. Further at step 408, a set of expert LLMs may be determined from the set of LLMs based on an evaluation of the first output for each of the set of tasks using one or more predefined evaluation metrics. In an embodiment, each expert LLM from the set of expert LLMs may correspond to one of the set of tasks. In an embodiment, the one or more predefined evaluation metrics may include, but are not limited to, Recall-Oriented Understudy for Gisting Evaluation (ROUGE) score, BERT (Bidirectional Encoder Representations from Transformers) score, Summary Consistency (SummaC) score, Exact Match (EM) score, F-measure (F1) score, BiLingual Evaluation Understudy (BLEU) score, and codeBLEU score.

Further at step 410, the knowledge database 116 may be determined based on a second output received by querying each of the set of expert LLMs based on a corresponding router-train dataset. In an embodiment, corresponding the routed-train dataset for each of the set of tasks may be determined by routing the train dataset to each of the set of expert LLMs based on a task expertise of each of the set of expert LLMs. Further at step 412, the set of expert LLMs may be merged to generate a base LLM using a merging technique. Further at step 414, a Parameter-Efficient Fine-Tuned (PEFT) model may be created by generating a plurality of adapters within the base LLM using an adapter creation technique.

Further at step 416, for each of a plurality of iterations, a knowledge distillation loss may be determined. In order to determine the knowledge distillation loss at step 418, a set of input-output pairs for each of the plurality of iterations may be determined based on the second output from each of the set of expert LLMs and a corresponding batch dataset. In an embodiment, the batch dataset may be generated from the train dataset using a batch generator for each of the plurality of iterations. In an embodiment, the knowledge distillation loss for each of the plurality of iterations may be determined by comparing a third output and the set of input-output pairs using a loss determination technique. In an embodiment, the third output may be generated by the PEFT model based on the batch dataset and the knowledge database 116. In an embodiment, the comparison of the third output and the set of input-output pairs may be performed using the loss determination technique. In an embodiment, the loss determination technique may include, but is not limited to, a combination of a soft loss and a hard loss. In an embodiment, the soft loss may include Kullback-Leibler (KL) divergence on softened logits and the hard loss may include cross-entropy loss with true labels. Further at step 420, a fused-expert LLM may be generated by iteratively updating the PEFT model based on the knowledge distillation loss.

Thus, the disclosed method 400 and system 100 try to overcome the technical problem of generating a fused-expert LLM from a set of LLMs by providing an efficient framework that selects, merges, and fine-tunes multiple expert LLMs to create a fused-expert LLM capable of performing multiple tasks with improved accuracy and reduced computational overhead. The disclosed method 400 and system 100 utilizes task-specific evaluation of the set of LLMs to identify expert LLMs for each task, further routes train dataset to these expert LLMs and stores a second output in the knowledge database. This enables the disclosed method 400 and system 100 to use knowledge distillation techniques to transfer the expertise of the set of expert LLMs into a single Parameter-Efficient Fine-Tuned (PEFT) model, thereby generating a fused-expert LLM.

By employing structured model merging techniques and adapter-based fine-tuning, the disclosed method 400 and system 100 ensures that the fused-expert LLM retains the domain-specific expertise of the set of expert LLMs while minimizing the need for extensive retraining or large-scale computation. Additionally, the knowledge distillation process ensures that the PEFT model iteratively learns to replicate expert LLM outputs with high efficiency. The fused-expert LLM generated through this method can be deployed for a variety of natural language processing tasks across different domains without requiring multiple independent LLMs, thereby reducing deployment complexity and improving utilization of computational resources.

In light of the above-mentioned advantages and the technical advancements provided by the disclosed method 400 and system 100, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described a method 400 and system 100 for generating a fused-expert LLM from a set of LLMs. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A method of generating a fused-expert large language model (LLM) from a set of LLMs, the method comprising:
receiving, by a processor, a set of tasks and a test dataset for each of the set of tasks;
determining, by the processor, a first output for each of the set of tasks by querying each of the set of LLMs based on the test dataset;
determining, by the processor, a set of expert LLMs from the set of LLMs based on an evaluation of the first output for each of the set of tasks using one or more predefined evaluation metrics,
wherein each expert LLM from the set of expert LLMs corresponds to one of the set of tasks;
determining, by the processor, a knowledge database based on a second output received by querying each of the set of expert LLMs based on a corresponding routed-train dataset;
merging, by the processor, the set of expert LLMs to generate a base LLM using a merging technique;
creating, by the processor, a Parameter-Efficient Fine-Tuned (PEFT) model by generating a plurality of adapters within the base LLM using an adapter creation technique; and
generating, by the processor, a fused-expert LLM by iteratively updating the PEFT model based on a knowledge distillation loss,
wherein the knowledge distillation loss is determined for each of a plurality of iterations based on a third output generated by the PEFT model based on a batch dataset and the knowledge database.

2. The method of claim 1, comprises:
splitting, by the processor, a task dataset into the test dataset and a train dataset using a splitting technique, and
wherein the corresponding routed-train dataset for each of the plurality of tasks is determined by routing the train dataset to each of the set expert LLMs based on a task expertise of each of the set expert LLMs.

3. The method of claim 2, wherein the batch dataset is generated from the train dataset using a batch generator for each of a plurality of iterations.

4. The method of claim 3, wherein determining the knowledge distillation loss comprises:
for each of the plurality of iterations:
determining, by the processor, a set of input-output pairs based on the second output from each of the set of expert LLMs and the corresponding batch dataset,
wherein the knowledge distillation loss for each of the plurality of iterations is determined by comparing the third output and the set of input-output pairs using a loss determination technique.

5. The method of claim 1, wherein the one or more predefined evaluation metrics comprise Recall-Oriented Understudy for Gisting Evaluation (ROUGE) score, BERT (Bidirectional Encoder Representations from Transformers) score, Summary Consistency (SummaC) score, Exact Match (EM) score, F-measure (F1) score, BiLingual Evaluation Understudy (BLEU) score, and codeBLEU score.

6. A system for generating a fused-expert large language model (LLM) from a set of LLMs, comprising:
a processor; and
a memory communicatively coupled to the processor, wherein the memory stores processor-executable instructions, which, when executed by the processor cause the processor to:
receive a set of tasks and a test dataset for each of the set of tasks;
determine a first output for each of the set of tasks by querying each of the set of LLMs based on the test dataset;
determine a set of expert LLMs from the set of LLMs based on an evaluation of the first output for each of the set of tasks using one or more predefined evaluation metrics,
wherein each expert LLM from the set of expert LLMs corresponds to one of the set of tasks;
determine a knowledge database based on a second output received by querying each of the set of expert LLMs based on a corresponding routed-train dataset;
merge the set of expert LLMs to generate a base LLM using a merging technique;
create a Parameter-Efficient Fine-Tuned (PEFT) model by generating a plurality of adapters within the base LLM using an adapter creation technique; and
generate a fused-expert LLM by iteratively updating the PEFT model based on a knowledge distillation loss,
wherein the knowledge distillation loss is determined for each of a plurality of iterations based on a third output generated by the PEFT model based on a batch dataset and the knowledge database.

7. The system of claim 6, wherein the processor-executable instructions, when executed by the processor cause the processor to:
split a task dataset into the test dataset and a train datase using a splitting technique, and
wherein the corresponding routed-train dataset for each of the plurality of tasks is determined by routing the train dataset to each of the set expert LLMs based on a task expertise of each of the set expert LLMs.

8. The system of claim 7, wherein the batch dataset is generated from the train dataset using a batch generator for each of a plurality of iterations.

9. The system of claim 8, wherein to determine the knowledge distillation loss, the processor-executable instruction cause the processor to:
determine, for each of the plurality of iterations, a set of input-output pairs based on the second output from each of the set of expert LLMs and the corresponding batch dataset,
wherein the knowledge distillation loss for each of the plurality of iterations is determined by comparing the third output and the set of input-output pairs using a loss determination technique.

10. The system of claim 6, wherein the one or more predefined evaluation metrics comprise Recall-Oriented Understudy for Gisting Evaluation (ROUGE) score, BERT (Bidirectional Encoder Representations from Transformers) score, Summary Consistency (SummaC) score, Exact Match (EM) score, F-measure (F1) score, BiLingual Evaluation Understudy (BLEU) score, and codeBLEU score.

11. A non-transitory computer-readable medium storing computer-executable instructions for generating a fused-expert large language model (LLM) from a set of LLMs, the computer-executable instructions configured for:
receiving a set of tasks and a test dataset for each of the set of tasks;
determining a first output for each of the set of tasks by querying each of the set of LLMs based on the test dataset;
determining a set of expert LLMs from the set of LLMs based on an evaluation of the first output for each of the set of tasks using one or more predefined evaluation metrics,
wherein each expert LLM from the set of expert LLMs corresponds to one of the set of tasks;
determining a knowledge database based on a second output received by querying each of the set of expert LLMs based on a corresponding routed-train dataset;
merging the set of expert LLMs to generate a base LLM using a merging technique;
creating a Parameter-Efficient Fine-Tuned (PEFT) model by generating a plurality of adapters within the base LLM using an adapter creation technique; and
generating a fused-expert LLM by iteratively updating the PEFT model based on a knowledge distillation loss,
wherein the knowledge distillation loss is determined for each of a plurality of iterations based on a third output generated by the PEFT model based on a batch dataset and the knowledge database.

12. The non-transitory computer-readable medium of claim 11, the computer-executable instructions are further configured for:
splitting a task dataset into the test dataset and a train dataset using a splitting technique, and
wherein the corresponding routed-train dataset for each of the plurality of tasks is determined by routing the train dataset to each of the set expert LLMs based on a task expertise of each of the set expert LLMs.

13. The non-transitory computer-readable medium of claim 12, wherein the batch dataset is generated from the train dataset using a batch generator for each of a plurality of iterations.

14. The non-transitory computer-readable medium of claim 13, wherein the computer-executable instructions are configured for determining the knowledge distillation loss by:
for each of the plurality of iterations:
determining a set of input-output pairs based on the second output from each of the set of expert LLMs and the corresponding batch dataset,
wherein the knowledge distillation loss for each of the plurality of iterations is determined by comparing the third output and the set of input-output pairs using a loss determination technique.

15. The non-transitory computer-readable medium of claim 11, wherein the one or more predefined evaluation metrics comprise Recall-Oriented Understudy for Gisting Evaluation (ROUGE) score, BERT (Bidirectional Encoder Representations from Transformers) score, Summary Consistency (SummaC) score, Exact Match (EM) score, F-measure (F1) score, BiLingual Evaluation Understudy (BLEU) score, and codeBLEU score.
